(19) United States
(12) Patent Application Publication
(10) Pub. No.: US 2008/0222094 A1
(43) Pub. Date: Sep. 11, 2008

(54) Apparatus and Method for Searching for Multiple Inexact Matching of Genetic Data or Information

(76) Inventor: Anthony Cox, Essex (GB)

Correspondence Address: KLAUBER & JACKSON, 411 HACKENSACK AVENUE, HACKENSACK, NJ, 07601, US

(21) Appl. No.: 10/585,842

(22) PCT Filed: Jan. 14, 2005
(86) PCT No.: PCT/GB05/00106

§ 371 Date: Jul. 12, 2006

(30) Foreign Application Priority Data
Jan. 16, 2004 (GB) 0400974.2

(51) Int. Cl. G06F 7/06; G06F 17/30

(52) U.S. Cl. 707/3; 707/E17.014

(57) ABSTRACT

A computer implemented method of searching genetic data or information for a plurality of query sequences in a set of target sequence fragments, allowing for mismatches at up to n sequence positions, including dividing each query sequence of the plurality of query sequences into n+1 query sequence segments and dividing each target fragment of the target sequence fragments into at least n+1 target sequence fragment segments, for each query sequence, constructing a first query group and a second query group by distributing query sequence segments there between such that at least n query sequence segments are contained in the second query group, constructing from each target fragment a first target group having a same distribution as the first query group, and for each query sequence, comparing the first query group with each first target group to identify potential matching target fragments.

The present invention relates to methods and apparatus for seeking, in a target sequence, an exact or inexact match to a given query sequence. In particular, but not exclusively, the invention relates to such methods and apparatus for use in searching for exact or close matches to each of a large number of genetic data query sequences in a large amount of genetic sequence target data such as a whole genome.

### DISCUSSION OF THE PRIOR ART

Computer implemented methods to efficiently search for one or more query data sequences in a target sequence dataset are used in a variety of fields, including searching for string query sequences in large numbers of general or text computer data files using tools such as UNIX grep and agrep, Internet Web searches using search engines such as Google (RTM) and searches for short sequences of polynucleotide or polypeptide data in large genome databases.

Wu and Manber, “A Fast Algorithm for Multi-Pattern Searching”, Tech Report TR-94-17, Department of Computer Science, University of Arizona, 1994, discloses a computer implemented method which simultaneously searches for exact matches between multiple query sequences and a target data set much more efficiently than can be achieved by carrying out corresponding multiple separate searches each for a single query sequence. Examples apply the method to searching large text files for hundreds of different English language words simultaneously.

In the method of Wu and Manber, a hash table is built, indexed by the hash value of all possible values of a particular end segment of the query sequences. Each entry in the hash table contains or points to query sequences ending S in the corresponding segment. Generally, many entries in the table will be empty, while some entries will point to multiple query sequences. The target sequence is scanned. For each possible matching segment of the target sequence a hash value is generated and used to look up potential query sequence matches using the hash table. Various other techniques, such as the use of a shift table, are used to improve efficiency.

Kim and Kim, “A fast multiple string-pattern matching algorithm”, Proc. of 17th AoM/IaoM Conf. on Computer Science, August 1999, discloses a broadly similar computer implemented method, but applied to searching for exact matches in a DNA target data set, as well as an English language text target data set. Each nucleotide base type, A, T, G and C, is ascribed a different two bit code, 00, 01, 10 and 11. Query sequences of nucleotide bases (eg TGCAGG) are thereby converted to binary query sequences (eg 011011001010). Each binary query sequence is split into a suffix and a prefix (eg 011011 and 001010). A hash function is applied to each prefix, and the hash value is used as an index into a hash table containing the corresponding suffixes.

A target sequence of nucleotide bases is scanned, base by base. At each position a target fragment of the same size as each query sequence is extracted, binary encoded and divided into prefix and suffix. The hash function is applied to the prefix and the result used as an index into the hash table to obtain the related query sequence suffixes, each of which is compared with the target fragment suffix to seek an exact match. The suffix comparison is straightforward and reasonably fast because the test is for an identical match.

Muth and Manber, “Approximate Multiple String Search”, Proc. of 7th Annual Symposium on Combinatorial Pattern Matching”, pp 75-86, 1996, discloses a computer implemented method for rapidly searching a large target text database for multiple query text strings, allowing for an error of one different character in finding an inexact match. Errors of one different character may be by deletion, insertion or substitution of a character. The algorithm uses a hash table approach similar to that discussed above. However, each query sequence is copied several times and each copy is modified by omitting a different character. The target database is scanned, and each possible matching target segment is processed in the same way as each query sequence. All the modified target segment copies are compared against all the modified query sequences.

The Muth and Manber method for inexact matching is relatively inefficient even when searching for matches subject to just one error, although better than the simplest multiple inexact matching method of generating all possible error perturbations of each query which should be considered a match, and feeding these to an exact matching mechanism. For a five character query sequence, five modified query copies must be compared, using the Muth and Manber method, against five modified copies of each possible target segment. When two errors are to be considered the number of different combinations which must be considered makes the technique impractical.

It would be desirable to provide an improved computer implemented method and associated apparatus for seeking matches between a large number of query sequences and a large target data set, allowing for a restricted number of differences, or mismatches between a query sequence and a matching target fragment.

It would particularly be desirable to provide such a method and apparatus which reduces the processing time required to make the necessary comparisons.

### SUMMARY OF THE INVENTION

The invention seeks to address the above and other problems of the related prior art. Generally, computer implemented methods of seeking matches between one or more query sequences and one or more target sequences, allowing for limited differences between the query and target sequences, are provided. Also provided are computer apparatus appropriately arranged or programmed to carry out such methods and computer readable media carrying corresponding program code.

The target sequences will usually be overlapping fragments of one or more longer target sequences, each target fragment selected to be the same size as each query sequence.

The invention is particularly useful when applied to the problem of seeking inexact matches between large numbers of query sequences and the target data. In the described embodiments, the invention is used in seeking inexact matches between a large number of short nucleic acid sequences, typically each between about 16 and 32 bases in length, and genome data, allowing for up to two sequence differences between each query and a matching genome fragment. Such an application is important in analysing the large amounts of nucleic acid data produced very rapidly using contemporary and envisaged genome analysis techniques.

The invention is implemented by dividing each query sequence into segments, distributing these segments between first and second segment groups, and using an efficient algorithm to seek potential matches between a first group of segments of each query sequence and a corresponding first group of segments of each target sequence fragment. This step is repeated using different distributions of segments from each query sequence and target sequence fragment in the compared first groups. The different distributions are arranged such that, whatever the positions of the potential mismatches between a target sequence fragment and a query sequence being compared, at least one distribution will place all mismatches, up to a certain number, into the second groups. Having found potential matches using a rapid comparison of the first groups, a detailed comparison of the corresponding second groups establishes the required exact or inexact matches.

The invention may be used with query sequence divided into just two segments, to seek matches subject to just one sequence difference, but is preferably used with four segments evenly distributed between the first and second groups to find matches subject to up to two sequence differences. In specific embodiments, the first and second groups are referred to as prefix and suffix, but the implied ordering is clearly not essential.

In particular, the invention provides a method of searching for a plurality of query sequences in a set of target sequence fragments, allowing for mismatches at up to n sequence positions, comprising the steps of:

a) logically dividing each query sequence and each target fragment into at least n+1 segments;

b) for each query sequence, constructing a first and a second query group by distributing the query sequence segments there between such that at least n segments are contained in the second query group. Preferably, the method further comprises:

c) constructing from each target fragment a first target group having the same segment distribution as the first query group; and

d) for each query sequence, comparing said first query group with each first target group to identify potential matching target fragments. The method may then proceed to find actual matching target fragments, subject to the mismatches to be allowed for, by comparing the second groups or by comparing directly the potentially matching query sequence and target fragment, parts or derivations thereof.

The segments may be formed from simple splitting of the elements of each sequence, or a more complex derivation of segments could be used involving, for example, coding or scrambling. In particular, a segment does not need to be formed from sequence items which are consecutive in the original sequence. For example, a sequence 123456 could be segmented as 123:456 or 135:246 or 621:435 and so on.

Preferably, all segments are the same size as each other, or as nearly the same size as possible given the number of segments and the size of the sequence being split.

Likewise, first and second query and target groups of segments are most conveniently formed using a simple concatenation of segments, in an arbitrary order, but more complicated schemes involving coding, convolution, scrambling and so on could be used. The relative sizes of the first and second groups may be optimized having regard to the available computer memory and other resources and features of the data. In the embodiments described, equal sizes of first and second groups is preferable, and allows for certain additional optimizations.

Each different or distinct distribution of segments into the first and second groups may be described as a hash function. To distribute four segments into two groups there are six such distinct hash functions, bearing in mind that the order in which the segments are placed in a group is immaterial, as long as the ordering is consistent for the purposes of comparing groups. Preferably, said query sequences and target sequence fragments are logically divided into an even number of segments, and the segments are distributed in equal numbers between the first and second query and target groups of segments.

To find all potential matches, steps (b) to (d) are repeated using different distributions of segments between said query groups, ideally using all distinct distributions of segments between said query groups, although it may not be necessary to use all distinct combinations to find at least one match.

For each potential matching target fragment identified in step (d), the following steps are preferably carried out:

(e) constructing a second target group having the same segment distribution as the second query group of the potentially matching query sequence; and

(f) comparing said second query group with said second target group to identify a match, allowing for mismatches in up to n sequence positions.

Step (f) may be efficiently carried out by applying an exclusive OR (XOR) operation between the second query group and second target group. This is applicable, in particular, if the sequences are encoded as binary numbers, for example using the 2-bit encoding to represent each of the four possible nucleotides in a DNA sequence. By first constructing a lookup table associating each possible outcome of the XOR operation with a match output, which may include a boolean match flag, a number of matches and so on, the output of the XOR operation may be processed more rapidly.

The method may be carried out by constructing a first query table indexed by possible values of the first query groups, the entries in the first query table providing access to each second query group by using as an index the value of a corresponding first query group. This first query table may be described as a hash table, as it represents a mapping between potential first query groups and actual second query groups according to one of the distinct segment distributions, or hash functions.

For each distinct distribution of query sequence segments, or hash function, there may then be constructed a second query table providing access to each second query group, the entries in the first query table providing references to appropriate entries in the second query table. For each first target group constructed in step (c), step (d) is preferably implemented by using said first target group to form an index into said first query table of course, the tables may be constructed in a variety of ways using any appropriate data structures such as lists, arrays and so on, which may be compressed or compacted as desired. The indexing and referencing may be achieved using pointers, direct numerical indexes, second level hashing and a variety of other techniques familiar to the skilled person.

If two distinct distributions of query sequence segments (or hash functions) are such that the first query group of one distribution is the same as the second query group of the other distribution and vice versa, the query tables for both of the distinct distributions may be constructed and/or used concurrently, simply by swapping first and second groups of data at appropriate points. This technique may be used to reduce the number of passes required through the target data by a factor of two.

The invention also provides computer apparatus, comprising a memory, for searching for a plurality of query sequences in a set of target sequence fragments, allowing for mismatches at up to n sequence positions comprising: a query groups constructor adapted to construct in the memory, for each query sequence, first and second query groups by logically dividing each query sequence into n+1 segments and distributing the query sequence segments between the first and second query groups in one or more ways such that at least n segments are contained in each second query group; a target groups constructor adapted to construct in the memory, for each target sequence fragment, one or more first target groups having segment distributions corresponding to the first query groups; and a first group comparator adapted, for each query sequence, to compare said one or more first query groups with corresponding ones of said one or more first target groups and to thereby output a result identifying potentially matching target fragments.

Such apparatus may typically be provided by a personal or desk top computer having a visual display unit, input devices, a central processing unit, volatile and non volatile memory and so on. The software for carrying out the method may be provided on removable media such as a CD ROM, or loaded over a network connection. Query and target data may be loaded and/or stored locally, and/or obtained over a network connection.

### BRIEF DESCRIPTION OF THE DRAWINGS

Embodiments of the invention will now be described, by way of example only, with reference to the accompanying drawings, of which:

FIG. 1 illustrates steps of a method embodying the invention;

FIG. 2 illustrates in more detail the build hash tables step of FIG. 1;

FIG. 3 illustrates the mask repeats step of FIG. 2;

FIG. 4 illustrates the count prefixes step of FIG. 2;

FIG. 5 illustrates the hash query sequences step of FIG. 2;

FIG. 6 illustrates the scan chromosome step of FIG. 1;

FIG. 7 illustrates the search for prefix, suffix step of FIG. 6;

FIG. 8 illustrates the search for suffix, prefix step of FIG. 6;

FIG. 9 illustrates apparatus embodying the invention; and

FIG. 10 illustrates data structures formed in memory by the apparatus of FIG. 9.

### DETAILED DESCRIPTION OF PREFERRED EMBODIMENTS

A general explanatory embodiment of the invention will first be provided, omitting complex implementation details. The invention provides a computer implemented method for seeking matches of a plurality of query sequences of nucleotide bases in a target sequence of nucleotide bases, or indeed a set or database of such sequences, allowing matching with up to 2 substitution errors, whereby a query sequence and a fragment of a target sequence differ at up to two positions.

Each query sequence is partitioned into four segments A, B, C and D, each containing a roughly equal number of bases. A function is defined fᵢ(ABCD)→(P,S) that forms a first group, which will be referred to as a prefix, from two of these four segments and a second group, or suffix, from the remaining two. If a query sequence has been binary encoded, it is straightforward to implement such a function using bit masking and bit shifting operations. Neglecting the ordering of bases within prefixes and suffixes, there are six such distinct functions:
f₁(ABCD)→(AB,CD)
f₂(ABCD)→(CD,AB)
f₃(ABCD)→(AC,BD)
f₄(ABCD)→(BD,AC)
f₅(ABCD)→(AD,BC)
f₆(ABCD)→(BC,AD)

Six passes are made through the target sequence. During each pass a different one of the above hash functions f₁ . . . f₆ is used. At each pass a hash table process similar to that described above in respect of the Kim and Kim document is used, except that in the present embodiment the hash function is used to split query sequences and target sequence fragments into prefixes and suffixes.

The first step of pass i is to place the suffix of each query sequence, computed by fᵢ, in a hash table using the corresponding prefix as key. The target database is then scanned, base by base. At each base a target fragment is extracted and fᵢ is used to generate the target fragment prefix and suffix. The prefix of the target fragment is used as a key into the hash table, to obtain a set of query sequence suffixes that are to be compared with the suffix of the target fragment.

If a target fragment is an exact match to a query sequence, then all six the hash functions f_{1 . . . 6} will generate identical prefixes for both the target fragment and the query sequence. Consider, instead, an inexact match between a target fragment and a query sequence, with differences at two base positions. If both differences occur in the same segment, then identical prefixes will be generated for the target fragment and query sequence by three of the six hash functions. The only other possibility is that the differences occur in two different segments, in which case one of the six hash functions will still generate identical prefixes for the target fragment and query sequence. Thus, whatever the position of the two differences between the target sequence fragment and the query sequence, at least one of the six hash functions yields an identical prefix for both sequences. For example, if the two differences lie in segments A and C then both differences lie in the suffix of f₄.

On finding an exact match between the prefixes of the target fragment and the query sequence, the prefix of the target fragment can be successfully used as a key into the hash table to find the group of suffixes of query sequences having the matched prefix. A search of this group, comparing the suffix of the target fragment with all the suffixes contained therein subject to up to two differences, will identify the matching query sequence. Of course, not all matching prefixes will have corresponding matching suffixes. Some matching prefixes may be associated with multiple matching suffixes, because several query sequences match the target sequence fragment subject to the up to two differences.

In hash table methods of exact matching, such as that disclosed by Kim and Kim above, it is sufficient to test for equality between the target fragment and query sequence suffixes. However, for the present purposes a comparison method is desired that is both computationally efficient and capable of detecting the two, or other number of differences between the suffix, or second group derived from the target fragment and the suffix, or second group, derived from the query sequence. This comparison may be carried out by first computing the bitwise exclusive-OR (XOR) of the binary encodings of the two suffixes.

The XOR of two binary numbers contains a 1 at a particular bit position if and only if the two numbers differ at that bit position, so that the number of differences between the suffixes can be counted by counting the positions of the XOR result which contain non-zero bits. Instead of performing this count for each comparison, a look-up table is preferably pre-calculated which contains the number of non-zero bits for all possible values of the XOR result. In this way, two suffixes can be compared by a single XOR operation followed by the retrieval of a value from the look-up table. The XOR of the binary encoding of the two suffixes will contain non zero bits at any base positions where the two suffixes differ. In particular, XOR results containing nonzero bits at two, one or zero base positions identify matches between the target fragment and the corresponding query sequence subject to two, one or zero substitution errors respectively.

### Detailed Embodiment

A detailed implementation of the invention, and in particular of the embodiment set out above, will now be described with reference to the figures. Again, this embodiment relates to searching for inexact matches of a large number of query sequences of DNA data in a large target DNA dataset, set out as a plurality of separate chromosome files, and the binary coding scheme discussed above is used. Of course, the method could easily be applied to other data types, and to search for inexact matches subject to different numbers and types of errors.

The implementation described makes use of the insight that the hash functions f₂, f₄ and f₆ described above may be obtained from the functions f₁, f₃ and f₅ by simply exchanging prefixes and suffixes. Advantage is taken of this symmetry by pairing f₁ with f₂, f₃ with f₄ and f₅ with f₆. The hash tables for both members of each pair are generated together, then both hash tables are accessed as the target sequence, set of sequences, or database is scanned. Thus only three scans through the target data are required.

The problem of searching through both strands of the target sequence or database is handled by generating the reverse complement of each query and hashing that as well. Thus on each scan through the target two hash tables are constructed for two complementary hash functions, and each table contains an entry for both the forward and reverse complement of each query sequence.

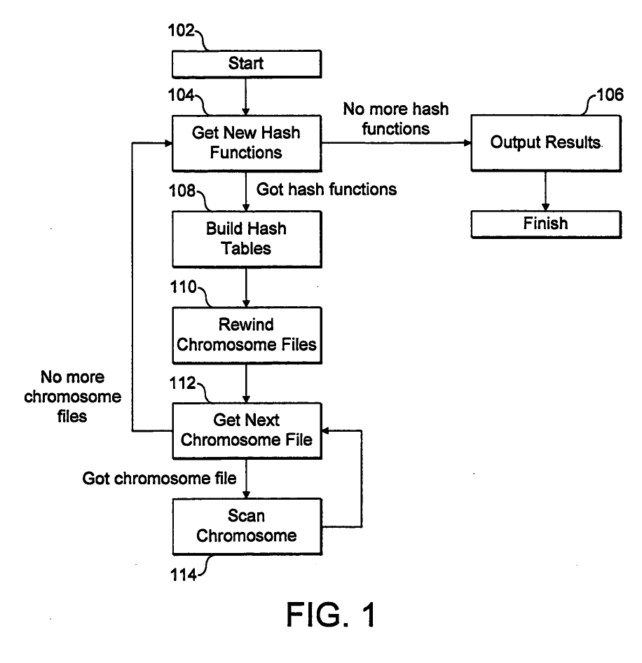

Referring to FIG. 1, the method is illustrated as a flow diagram. From the start box 102, a new pair of hash functions is selected from f₁ . . . f₆ in the get new hash functions step 104. If all three pairs of hash functions have already been used then control passes to an output results step 106. Otherwise, two hash tables are built by applying the new pair of hash functions to all of the query sequences and their reverse complements in step 108.

Having built the hash tables, the target sequence data is prepared in the step 110 of rewinding the chromosome files, in preparation for the get next chromosome file step 112 which cycles with the scan chromosome step 114 until all chromosome files have been scanned, and matches between the query sequences and target segments have been recorded. When all chromosome files have been scanned control is returned to the get new hash functions step 104 mentioned above.

When all chromosome files have been scanned using all pairs of hash functions the match results are output in output results step 106. This is implemented by a function that interrogates the relevant data structure, which is matchstore discussed below, and outputs the results of the matching process for each query sequence. In the present implementation this output takes the form of one line of ASCII characters for each query sequence, which can be directed to a file. However, the output could equally well be directed to a database.

The get next chromosome file step 112 gets the next of a sequence of chromosome files from a predefined source. In the present implementation a list of file structure directory entries is traversed, but all the chromosome files could equally well be extracted from a database.

The build hash tables step 108 and scan chromosome step 114 will now be described in more detail.

### Build Hash Tables Step

The build hash tables step is implemented using a software function that constructs and populates the data structures outlined below. A C/C++ style notation A[i] is used to denote the i^{th} element of an array A, with numbering of elements starting at zero.

MatchStore: this data structure contains one entry for each query sequence, and is adapted to hold the match results. In the present implementation 8 bytes are used for each entry, and the structure is built as a re-sizeable array, for example using the “vector” template class in the C++ Standard Template Library. Each entry stores the following information:
a repeat mask flag to show whether the query sequence was repeat masked (discussed below) or, if not repeat masked:
counts of the number of exact, single error and 2 error matches found (each count has a maximum values of 255 in the present implementation); and, if there is a unique best match:
position of the unique best match (comprising chromosome, position on chromosome, forward or reverse strand); and
positions of the differences between the query and its best match (if there are any).

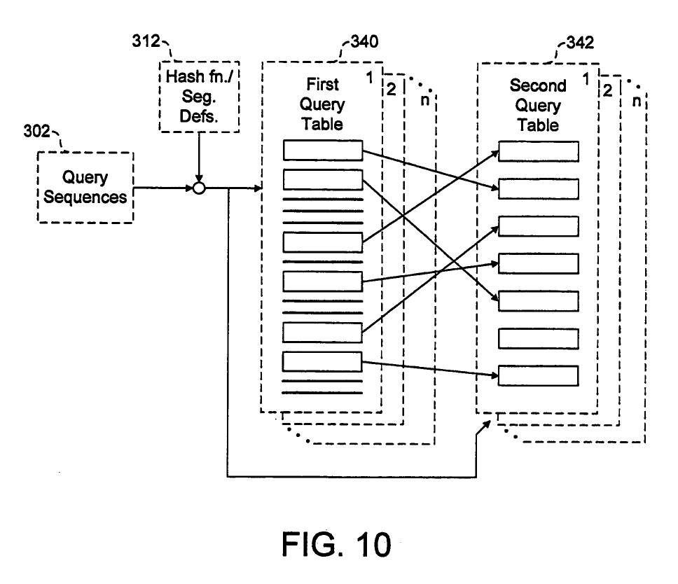

L1: this data structure contains two entries for each non-repeat masked query sequence, and implements the second query tables mentioned above and illustrated in FIG. 10. Each entry contains the binary encoding of each query sequence suffix (4 bytes in the present implementation). Each entry also contains the entry number of the query sequence in the MatchStore structure, and a flag denoting whether this is the forward or reverse strand of the query sequence, together requiring another 4 bytes in the present implementation.

P1: this data structure contains one entry for each of the possible values of prefix and implements the hash tables, or first query tables mentioned above and illustrated in FIG. 10. Noting that the prefix is represented as a binary number having a value of between 0 and 4^{prefixLength}-1 inclusive, prefixLength being the number of bases in each prefix, and that there are four different base types, there are 4^{prefixLength} possible prefixes. Each entry of P1 acts as a pointer into L1, although 32 bit unsigned integers are used in the present implementation. If X is the binary encoding of a particular prefix, then the entries of L1 corresponding to query sequences that have that prefix are held consecutively in L1, starting with entry P1[X] and stopping at the entry immediately before P1[X+1].

L2 and P2 are structures which are essentially the same as L1 and P1, except that the roles of the prefix and suffix are reversed, thereby implementing the reverse hash function.

To populate the data structures, the query sequences are read in a predefined order from one or more source files, with some mechanism provided to identify when all the query sequences have been read so that the source files can be rewound. In the present implementation query sequences are read from an ASCII file, but they could equally well be extracted from a database or other storage mechanism.

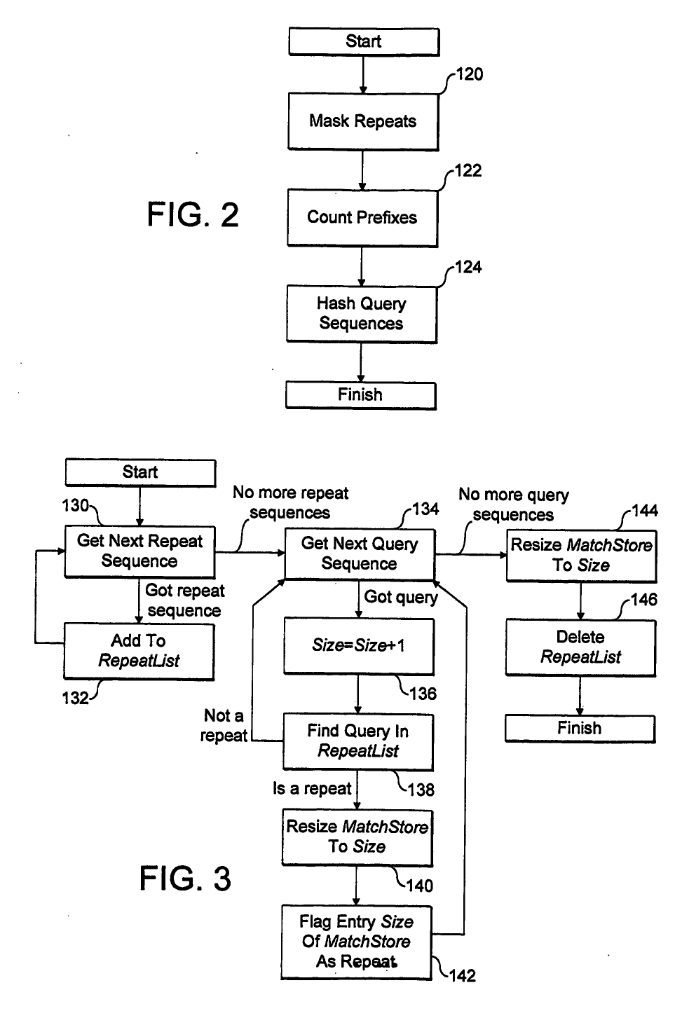

The build hash tables step 108 is broken down into a number of sub-steps as shown in FIG. 2. A mask repeats step 120 is followed by a count prefixes step 122, then a hash query sequences step 124.

The mask repeats step 120 is illustrated in more detail in FIG. 3. The aim of this step is to prevent the matching process from being dramatically slowed down or from becoming inefficient by the matching of any one query sequence to a large number of different target sequence segments.

In the mask repeats step 120 a repeat list containing DNA repeat sequences already known to recur, or expected to recur many times in the target data is read. This is illustrated in FIG. 3 as the cycle between the get next repeat sequence step 130 and the add to repeat list step 132.

When there are no more repeat sequences to be read, processing moves on to reading the query sequences, in the get next query sequence step 134. For every query sequence read, a size variable, initially set to zero, is incremented in step 136. If the new query is not found in the repeat list by the subsequent find query in repeat list step 138 then control is returned to the get next query sequence step 134, for the next query sequence to be read. If the new query is found in the repeat list by step 138 then the MatchStore structure is resized in step 140 to the size indicated by the size variable, and the repeat mask flag of the MatchStore entry indexed by the size variable is set in step 142. Control is then returned to the get next query sequence step 134.

When there are no more query sequences to be read, MatchStore is resized in step 144 to the size indicated by the size variable, and the repeat list is deleted in step 146.

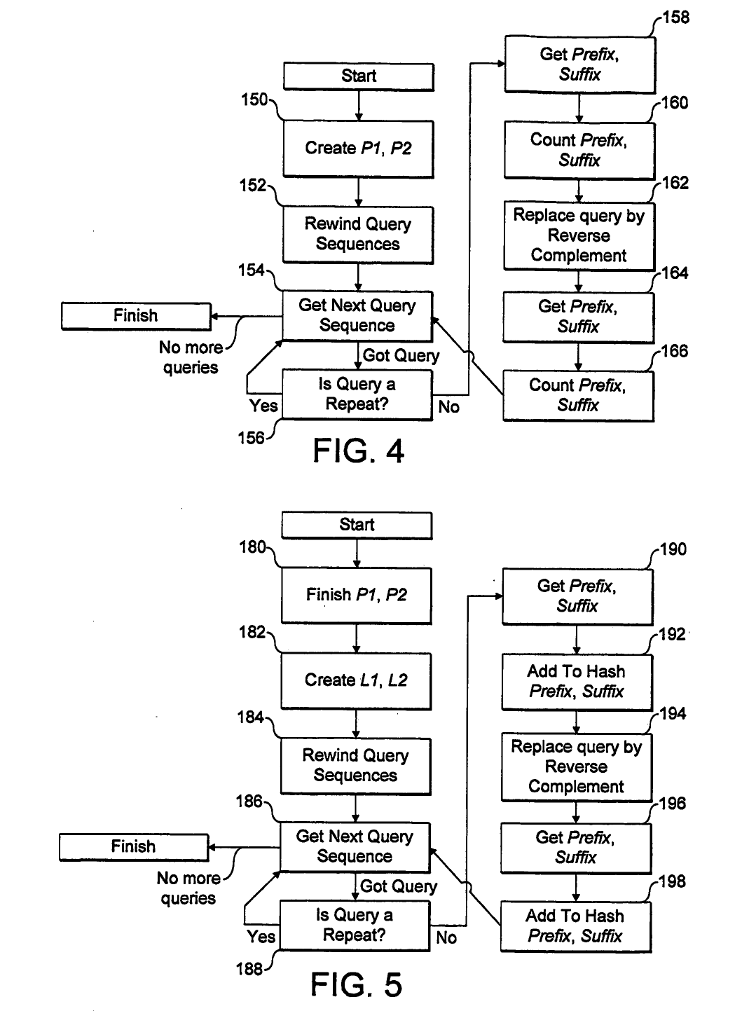

The count prefixes step 122 of FIG. 2 is illustrated in more detail in FIG. 4. The aim of the count prefixes step is to count the number of occurrences in the query sequences of each possible prefix into P1, and of each possible suffix into P2. The structures P1 and P2, as described above, are first created, in step 150. The query sequence file of files are then rewound, in step 152.

The query sequences are then read and processed sequentially by a repeating series of steps beginning with a get next query sequence step 154, until no more queries are available to process. Each query sequence read in step 154 is tested in step 156 to determine if it is found in the repeat list discussed above, by checking the appropriate repeat mask flag of MatchStore. If it is found in the repeat list then control is passed back to step 154 to get the next query sequence. Otherwise, the prefix and suffix of the query sequence are derived in step 158, and counted into P1 and P2 respectively in step 160 by incrementing the element of P1 or P2 indexed by the prefix or suffix. The query sequence is then replaced-by its reverse complement in step 162, the prefix and suffix of the reverse complement are derived in step 164 and the newly derived prefix and suffix are counted into P1 and P2 in step 166. Control is then returned to the get next query sequence step 154.

The hash query sequences step 124 of FIG. 2 is illustrated in more detail in FIG. 5. The aim of this step is to populate the L1 and L2 structures. The first sub-step is the finish P1 P2 step 180 in which P1 and P2 are traversed, and converted into cumulative sums. The last elements of P1 and P2 then indicate the total number of non repeat masked query sequences, including both forward and reverse complements, and hence the required sizes for L1 and L2. These sizes are used in the subsequent step 182 of creating the L1 and L2 structures, following which the one or more query sequence files are rewound in step 184, ready to be read again.

The query sequences are then read and processed sequentially by a repeating series of steps beginning with a get next query sequence step 186, until no more queries are available to process. Each query sequence read in step 186 is tested in step 188 to determine if it is found in the repeat list discussed above, by checking the appropriate repeat mask flag of MatchStore. If it is found in the repeat list then control is passed back to step 186 to get the next query sequence. Otherwise, the prefix and suffix of the query sequence are derived in step 190, and written into the L2 and L1 structures respectively in step 192. The query sequence is then replaced by its reverse complement in step 194, the prefix and suffix of the reverse complement are derived in step 196 and the newly derived prefix and suffix are written into L2 and L1 in step 198. Control is then returned to the-get next query sequence step 186.

### Scan Chromosome Step

In this step a chromosome sequence is scanned, base by base. At each base position, where possible, a target sequence fragment of the same length as the query sequences is extracted. This may not always be possible: if the target fragment contains a code indicating an unknown or ambiguous base then the fragment is ignored, and the process skips to the next useable fragment.

Each chromosome file could be an ASCII file, but in the present implementation one or more binary files using the 2-bits-per-base binary encoding discussed above provide the target data. Ambiguity codes are handled by maintaining a separate list of “valid” regions free from ambiguity codes, each region being defined by a start and a stop position.

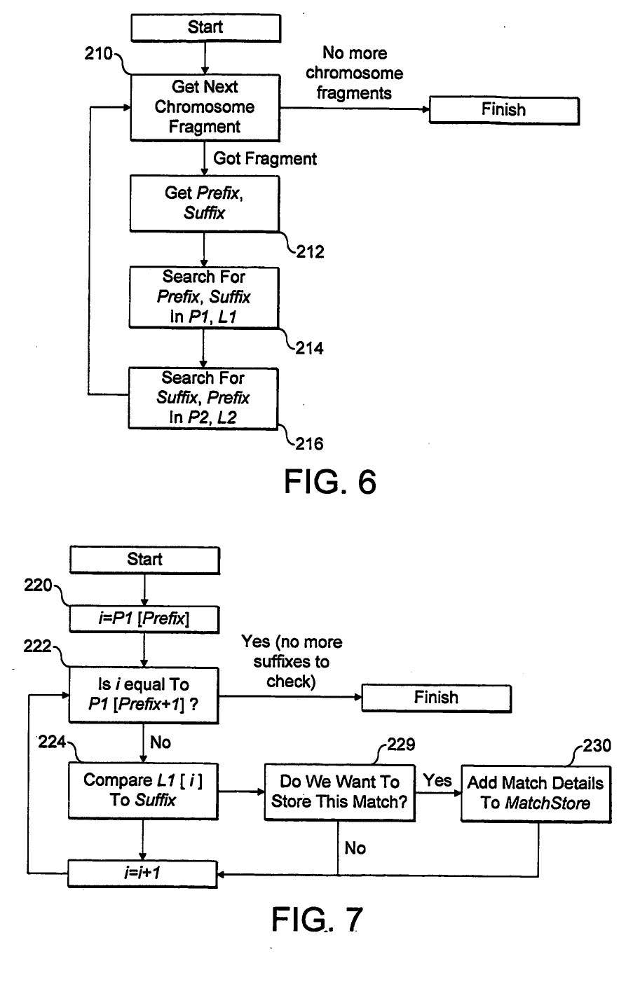

The scan chromosome step is illustrated in more detail in FIG. 6. The get next chromosome fragment step 210 obtains the next target fragment available from within the valid regions mentioned above. The prefix and suffix of the target fragment are then obtained using the current hash functions in step 212. The target fragment prefix and suffix are sought in P1 and L1 respectively in step 214, and the suffix and prefix are sought in P2 and L2 respectively in step 216. Control is then passed back to the get next chromosome fragment step 210.

When no more chromosome fragments are available the scan chromosome task 114 of FIG. 1 is complete.

The step 214 of seeking the current target fragment prefix and suffix in P1 and L1 is further illustrated in FIG. 7. In step 220 a count variable i is set to the value of P1 corresponding to the present target fragment prefix. Variable i is then used to count through the entries of L1 corresponding to all the queries having the same prefix, by means of increment step 226 until i is equal to the value of P1 corresponding to the next possible prefix, as determined by test step 222, at which point the step 214 of FIG. 6 is complete.

For each value of count variable i, the query sequence suffix held in L1[i] is compared, in step 224, to the present target fragment suffix. In this way, the target suffix is compared with the suffixes of all query sequences that have the same prefix as the target fragment. As discussed above, this is achieved by taking the bitwise exclusive-OR of the binary encoding of the target suffix with the binary encoding of each query suffix, and then using the result to index into a lookup table to find the number of mismatches and their positions.

Comparisons revealing more than two mismatches are of no interest in the present implementation. However, it will be recalled that matches having mismatch errors in two distinct segments will be found using only one of the six hash functions, those having mismatch errors in only one segment will be found using two of the hash functions, and exact matches will be found using all six hash functions. For this reason, the results of comparisons revealing mismatches in two distinct segments are always stored, but by choosing to ignore other types of matches on certain passes it is ensured that an exact or inexact match is registered only once.

The decision whether or not to store a match found using comparison step 224 is made in store decision step 229. If a positive decision is made, the comparison results are stored in the MatchStore structure in step 230. In either case, control is returned to test step 222 by way of increment step 226.

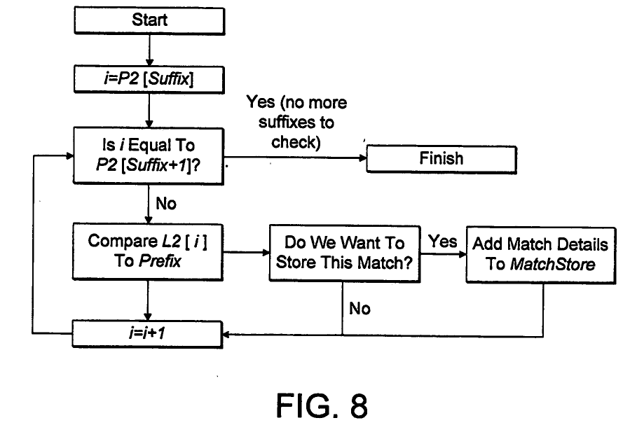

The step 216 of seeking the current target fragment suffix and prefix in P2 and L2 respectively is further illustrated in FIG. 8. It will be seen that the steps of FIG. 8 are identical to those of FIG. 7, except that P1 is replaced by P2, L1 by L2, “prefix” by “suffix”, and “suffix” by “prefix”, such that the roles of the suffix and prefix are reversed and the complementary hash function implemented.

### Apparatus

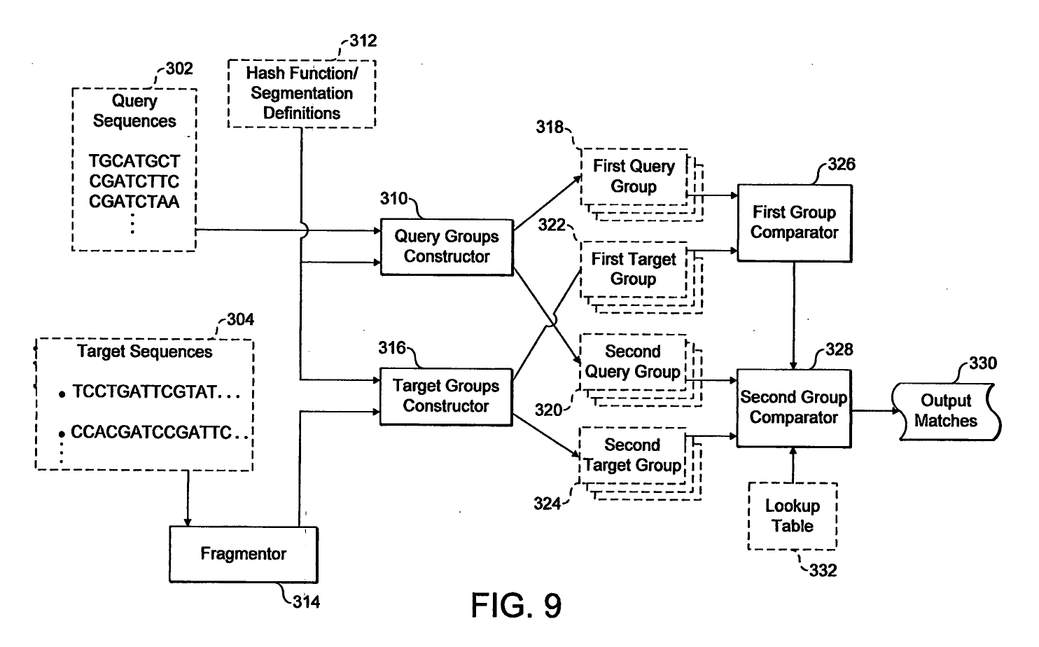

Computer apparatus for putting the above described methods into effect is illustrated in FIG. 9. Query sequences 302 and target sequences 304 are stored in volatile or non volatile memory, for example in a database or on a hard disk drive. A query groups constructor element 310 is provided by software running on the computer, and constructs query groups fromm segments of the query sequences, as determined by data or program elements 312 representing the hash functions, or segmentation distributions to be used.

A fragmentor element 314 takes target sequence data 304 and from it forms target sequence fragments of the same length as the query sequences. The fragmentor avoids target sequences containing ambiguity codes by referring to a list of valid regions.

Target sequence fragments are passed to the target groups constructor 316, which constructs target groups of segments of the target fragments, also under the control of the data or program elements 312 defining the hash functions or segment distributions to be used.

The query groups constructor 310 forms pairs of first and second query groups 318, 320 of segments for each query sequence and each hash function. The target groups constructor 316 forms corresponding pairs of first and second target groups 322, 324 of target fragment segments, for each target sequence fragment and each hash function.

Each first target group 322 is compared with each first query group 318 by means of a first comparator mechanism 326, which is implemented using the hash table methodology discussed above, and illustrated as the first query table 340 in FIG. 10. An exact match between a first query group 318 and a first target group 322 indicates a possible match between the corresponding full query sequence and target fragment. This possible match is signalled to a second group comparator mechanism 328 which compares the associated second query and target groups, making use of the second query table 342 illustrated in FIG. 10. If the second groups match, subject to the maximum number of mismatches allowed according to the hash functions 312 used, then a match result is output by output element 330. The second group comparison is preferably implemented, as discussed above, by an XOR operation, the result of which is used as an index into a lookup table 332.

Some data structures formed in memory by the apparatus of FIG. 9 and the method described in connection with FIGS. 1 to 8 are shown in FIG. 10. Query sequences 302 and hash function or segmentation definitions 312 are jointly used to create a set of first query tables 340. There is a query table for each hash function, each table being indexed by the possible values of first query groups of query sequence segments which could be produced using the corresponding hash function. The elements of each first query table, or hash table, provide references into entries of a corresponding second query table 342. There is a second query table for each hash function. Each second query table contains the suffixes, or second query groups of segments actually produced using the corresponding hash function.

Using the data structures illustrated in FIG. 10, a target fragment is processed using a hash function to form a prefix, or first query group, and the corresponding entry in the first query table 340 for the same hash function is used to find the entries in the appropriate second query table 342 containing query sequence suffixes which might confirm an exact or in exact match.

Of course, the query tables for the different hash functions do not need to coexist in memory at the same time, although simultaneous construction and/or use of tables corresponding to a complementary pair of hash functions may be advantageous, as already discussed.

### Specific Implementation

The described method and apparatus were used, in particular, to search for exact or inexact matches between large numbers of short DNA query sequences and target sequences in a database containing relatively small numbers of large DNA sequences structured in files by chromosome. In one implementation, a batch of about 12 million query sequences of between 16 and 32 bases in length were scanned against a target database of build 33 of the human genome. This version of the human genome comprised files for each of the 22 autosomal chromosomes and each of the 2 sex chromosomes, containing about 3 billion bases in total. This was carried out on an Intel Pentium desktop computer with a microprocessor clock speed of 2 GHz and 1 GByte of RAM, running the well known RedHat Linux 7.2 operating system. The method was implemented using software code written in C++ and compiled using the well known GNU C/C++ compiler.

### Variations and Extensions

The methods discussed in detail above are a special case of a more general method that seeks matches subject to m differences by splitting query sequences into n fragments, where n>m. Generally, ⁿCₘ=n|/(m|(n−m)|) passes through the target databases will be used, each time carrying out the hash table scheme using a different one of the ⁿCₘ ways of choosing n minus m fragments for exact matching the prefixes and m fragments for inexact matching of the suffixes. In the above detailed examples, setting n=2m allows hash functions to be paired, leading to greater computational efficiency.

By way of example, if n=2 and m=1, then the method will find inexact matches subject to a single mismatch using two hash functions, which are trivial in that they merely define a prefix and suffix, and a corresponding suffix and prefix. If n=3 and m=2, then the method will find inexact matches subject to two mismatches using three hash functions, but may be much less efficient than using n=4 and m=2 because the sizes of the hash tables stored in the P data structures will be rather small, and the number of query suffixes for any given query prefix rather large.

If n=6 and m=3, all three-error matches can be found in 20 passes through the target data, or in 10 passes if complementary hash functions are paired together as already described.

For a given number of allowable errors to accommodate an inexact match, i.e. m, a higher value of n would be expected to make each pass faster, but there will be more passes to complete. For greater n, the lookup tables P1 and P2 also rapidly become very large, and may not fit into fast memory. To fine tune the method to cope with this, P1 and P2 may contain only most significant bits of the prefixes, with the least significant bits being accommodated in L1 and L2. However, lookup of suffix information then requires an additional binary search phase following the initial table lookup. This scheme has been tried for query sequence lengths greater than 26 bases, and it works well without being detrimental to the speed of the method.

The number of allowable errors in an inexact match m is likely to be governed by the application to which the method is being put, while the value of n to optimize the method will be very hardware dependent, in particular being governed by the amount of fast memory available to accommodate the required data structures.

1-24. (canceled)

25. A computer implemented method of searching genetic data or information for a plurality of query sequences in a set of target sequence fragments, allowing for mismatches at up to n sequence positions, comprising:
a) dividing each query sequence of the plurality of query sequences into n+1 query sequence segments and dividing each target fragment of the target sequence fragments into at least n+1 target sequence fragment segments;
b) for each query sequence of the plurality of query sequences, constructing a first query group and a second query group by distributing query sequence segments there between such that at least n query sequence segments are contained in the second query group;
c) constructing from each target fragment a first target group having a same distribution as the first query group; and
d) for each query sequence of the plurality of query sequences, comparing the first query group with each first target group to identify potential matching target fragments.

26. The computer implemented method of claim 25, wherein steps (b) to (d) are repeated using different distributions of query sequence segments between the first query group and the second query group.

27. The computer implemented method of claim 26, wherein steps (b) to (d) are repeated using distinct distributions of query sequence segments between the first query group and the second query group

28. The computer implemented method of claim 25, further comprising, for each potential matching target fragment of the potential matching target fragments identified in step (d):
(e) constructing a second target group having a same segment distribution as the second query group of the potential matching query sequences; and
(f) comparing the second query group with the second target group to identify a match, allowing for mismatches in up to n sequence positions.

29. The computer implemented method of claim 28, wherein step (f) is carried out by applying an exclusive OR operation to a binary representation of each of the second query group and the second target group.

30. The computer implemented method of claim 29, wherein a result of the exclusive OR operation is analyzed using a lookup table.

31. The computer implemented method of claim 25, further comprising: for each distinct distribution of query sequence segments, constructing a first query table indexed by possible values of the first query groups, wherein the entries in the first query table provide access to each second query group by using as an index the value of a corresponding first query group.

32. The computer implemented method of claim 31, further comprising: for each distinct distribution of query sequence segments, constructing a second query table providing access to each second query group, wherein the entries in the first query table provide references to appropriate entries in the second query table.

33. The computer implemented method of claim 31, further comprising: for each first target group constructed in step (c), implementing step (d) by using each first target group to form an index into the first query table.

34. The computer implemented method of claim 31, wherein, if two distinct distributions of query sequence segments are such that the first query group of a first distribution is the same as the second query group of a second distribution, respective first query tables for each of the two distinct distributions are at least one of constructed and used concurrently.

35. The computer implemented method of claim 25, wherein target sequence fragments in the set of target sequence fragments comprise overlapping fragments of one or more target sequences.

36. The computer implemented method of claim 22, wherein each query sequence of the plurality of query sequences and the target sequence fragments comprise biochemical sequence data.

37. The computer implemented method of claim 36, wherein each query sequence of the plurality of query sequences and the target sequence fragments are binary encoded.

38. The computer implemented method of claim 25, wherein n is at least two.

39. The computer implemented method of claim 25, wherein each query sequence of the plurality of query sequences and the target sequence fragments are divided into an even number of query sequence segments and target sequence fragment segments, and further wherein the query sequence segments and the target sequence fragment segments are distributed in equal numbers between the first query group and the second query group and the first target group and a second target group.

40. The computer implemented method of claim 25, wherein the n+1 query sequence segments are formed from a splitting of each query sequence of the plurality of query sequences.

41. The computer implemented method of claim 25, wherein the n+1 query sequence segments are formed from a coding or scrambling of each query sequence of the plurality of query sequences.

42. The computer implemented method of claim 25, further comprising: using a hash function to split each query sequence of the plurality of query sequences and the target sequence fragments into prefixes and suffixes.

43. The computer implemented method claim 25, further comprising: constructing or computing at least one hash function table.

44. An apparatus for searching genetic data or information, comprising:
a memory device, wherein the memory device stores information for searching for a plurality of query sequences in a set of target sequence fragments, allowing for mismatches at up to n sequence positions;
a processing device, wherein the processing device constructs a plurality of first query groups and a plurality of second query groups for storage in the memory device, wherein the processing device constructs, for each query sequence of the plurality of query sequences, a first query group and a second query group, by dividing each query sequence of the plurality of query sequences into n+1 query sequence segments and distributing the query sequence segments between the first query group and the second query group in one or more ways such that at least n query sequence segments are contained in each second query group, and further wherein the processing device constructs a first target group for each target sequence fragment in the set of target sequence fragments, wherein the processing device constructs a plurality of first target groups, and further wherein one or more of the first target groups have query sequence segment distributions corresponding to the first query groups, and further wherein the processing device, for each query sequence of the plurality of query sequences, compares one or more of the first query groups with one or more of the first target groups and identifies potentially matching query sequences and potentially matching target sequence fragments; and
an output device for outputting information regarding the potentially matching query sequences and the potentially matching target sequence fragments.

45. The apparatus of claim 44, wherein the processing device constructs, for each query sequence of the plurality of query sequences and for each target sequence fragment, respectively, a plurality of first query groups and second query groups having distinct distributions of segments between the first query groups and the second query groups.

46. The apparatus of claim 44, wherein the processing device constructs, at least for each target sequence fragment identified by the processing device as a potentially matching target sequence fragment of the potentially matching target sequence fragments, one or more second target groups, wherein one or more of the second target groups has a segment distribution corresponding to the second query groups, and further wherein the processing device, for each identified potentially matching query sequence and for each potentially matching target sequence fragment, compares a corresponding second query group and a second target group to identify a match allowing for mismatches in up to n sequence positions.

47. The apparatus of claim 44, wherein the processing device, for each distinct distribution of a query sequence segment, constructs a first query table indexed by possible values of the first query groups, wherein entries in the first query table provide access to each second query group by using as an index a value of a corresponding first query group.

48. The apparatus of claim 47, wherein the processing device, for each distinct distribution of a query sequence segment, constructs a second query table, wherein the second query table provides access to each second query group, and further wherein the entries in the first query table provide reference to appropriate entries in the second query table.

49. The apparatus of claim 44, wherein the processing device forms the n+1 query sequence segments by splitting each query sequence of the plurality of query sequences.

50. The apparatus of claim 44, wherein the processing device forms the n+1 query sequence segments by coding or scrambling each query sequence of the plurality of query sequences.

51. The apparatus of claim 44, wherein the processing device uses a hash function to split the plurality of query sequences and the target sequence fragments into prefixes and suffixes.

52. The apparatus of claim 44, wherein the processing device constructs or computes at least one hash function table.

53. The apparatus of claim 44, wherein the apparatus is a personal computer or a desk top computer.

54. A computer program for use in connection with a device for searching genetic data or information and comprising a computer program code for searching for a plurality of query sequences in a set of target sequence fragments, allowing for mismatches at up to n sequence positions, comprising:
a first program module or portion for constructing in a memory associated with the computer, for each query sequence of the plurality of query sequences, a first query group and a second query group by dividing each query sequence of the plurality of query sequences into n+1 query sequence segments and distributing the query sequence segments between the first query group and the second query group in one or more ways such that at least n query sequence segments are contained in each second query group;
a second program module or portion for constructing in the memory, for each target sequence fragment of the set of target sequence fragments, one or more first target groups having target sequence fragment segment distributions corresponding to the first query groups; and
a third program module or portion for comparing, for each query sequence of the plurality of query sequences, one or more first query groups with corresponding one or more first target groups and to output a result identifying potentially matching query sequences and potentially matching target sequence fragments.

55. The computer program of claim 54, wherein the computer program is stored on a removable computer-readable storage medium.

56. The computer program of claim 54, wherein the computer program is loadable over a network connection.
